(19) United States
(12) Patent Application Publication
(10) Pub. No.: US 2024/0373270 A1
(43) Pub. Date: Nov. 7, 2024

(54) EFFICIENT SOUNDING LEVERAGING MULTILINK OPERATION

(71) Applicant: Cisco Technology, Inc., San Jose, CA (US)

(72) Inventors: Malcolm M. SMITH, Richardson, TX (US); Brian D. HART, Sunnyvale, CA (US); Matthew A. SILVERMAN, Shaker Heights, OH (US)

(21) Appl. No.: 18/313,022

(22) Filed: May 5, 2023

(51) Int. Cl. H04W 24/10; H04L 5/00

(52) U.S. Cl. CPC H04W 24/10; H04L 5/0048

(57) ABSTRACT

A system and method are disclosed for characterizing the propagation properties of a plurality of radio frequency links without sounding each link. An access point sounds a first link and receives, from a station connected to the access point, channel state information, which may be compressed, from which it constructs a geometric representation applicable to the plurality of radio frequency links. The access point performs a sounding of a second link and receives from the station delta information, which may be compressed, regarding propagation differences between the first link and the second link. The access point then derives the propagation characteristics of the second link based on the geometric representation and the delta information. In some cases, the delta information is null, indicating no difference between the two links.

### TECHNICAL FIELD

Embodiments presented in this disclosure generally relate to the physical layer of wireless networking. More specifically, embodiments disclosed herein include finding the radio frequency characteristics of a wireless channel used in wireless networking.

### BACKGROUND

Because of the effect of terrain and obstacles, wireless signals propagate in multiple paths. To minimize or use the multipath effect, sounding is used to process a multidimensional spatial-temporal signal encountering these obstacles and determine channel characteristics. In sounding, a transmitter sends out a signal that excites, i.e., sounds, the channel. The output of the channel is observed by the receiver and stored. The channel's impulse response is obtained from the knowledge of the transmitted and received signal.

The sounding signal may be a broadband multi-tone test signal. At the receiver, the arriving signal is correlated with a local copy of the test signal. Due to the impulse-like auto-correlation function of the test signal, the correlator output provides the measured channel impulse response.

When many radio channels are available on a device, performing sounding on all those channels takes a significant amount of time. What is needed is a way of reducing the time for finding characteristics of all of the channels of a multi-channel device.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A depicts an access point (AP) operating to sound stations (STAs).

FIG. 1B depicts an example computing device configured to perform various aspects of the present disclosure, according to some embodiments of the present disclosure.

FIG. 2 depicts a basic sounding structure.

FIG. 3 depicts frames using in sounding.

FIG. 4A depicts a flow of operations for sounding, in an embodiment.

FIG. 4B depicts a flow of operations for sounding, in an embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a method for characterizing propagation paths of a plurality of radio frequency (RF) links including a first RF link and a second RF link. The method includes sounding the first RF link with a sounding signal, obtaining first channel state information for the first RF link from a station having a receiver receiving the sounding signal, the first channel state information characterizing propagation over the first RF link to the receiver, converting the first channel state information into a geometric representation that applies to the plurality of RF links, and obtaining second channel state information for the second RF link based on the geometric representation.

Another embodiment presented in this disclosure is a system for characterizing wireless propagation paths of a plurality of radio frequency links. The system includes an access point having multiple transmitters and receivers. The plurality of RF links, including a first RF link and a second RF link, is available between the access point and a station having multiple transmitters and multiple receivers. The access point is configured to: sound the first RF link with a sounding signal; obtain first channel state information for the first RF link from the station, the first channel state information characterizing propagation over the first RF link to one receiver of the multiple receivers of the station; convert the first channel state information into a geometric representation that applies to the plurality of RF links; and obtain second channel state information for the second RF link based on the geometric representation

Another embodiment presented in this disclosure is a non-transitory computer-readable medium encoding instructions, which, when executed by a processor of an AP coupled to a wireless medium, cause the AP to characterize wireless propagation paths of a plurality of radio frequency channels including a first RF channel and a second RF channel by: sounding the first RF link with a sounding signal; obtaining first channel state information for the first RF link from a station having a receiver receiving the sounding signal, the first channel state information characterizing propagation over the first RF link to the receiver; converting the first channel state information into a geometric representation that applies to the plurality of RF links; and obtaining second channel state information for the second RF link based on the geometric representation.

### Example Embodiments

When multiple wireless links are used, radio waves traveling over the wireless link traverse many different paths between a transmitter and receiver and encounter diffraction due to obstacles in those paths. Thus, each path has a distinct amplitude, delay (runtime of the signal), the direction of departure from the transmitter, and the direction of arrival at the receiver, resulting in signals arriving at the receiver with different phase shifts relative to each other. The received signals combine destructively or constructively at the receiver, resulting in small-scale fading, especially when the receiver is mobile. The obstacles encountered in the different paths also lead to shadowing, resulting in large-scale fading. In addition, the different runtimes of the signals lead to intersymbol interference at the receiver.

To deal with small-scale, large-scale fading, and intersymbol interference, a model capturing the important parameters of the channel is selected. Actual measurements of the wireless channel are taken to supply the parameters. Measurements are supplied by sounding the channel, which includes sending known signals over the channel and receiving a response from the receiver indicating how the known signal was received. Once the channel is well-characterized, the transmitter and receiver can adjust to improve the reception quality.

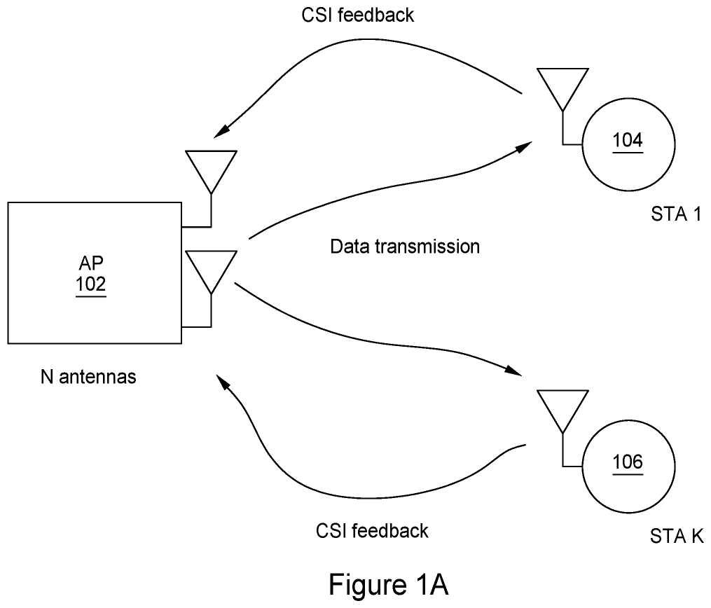

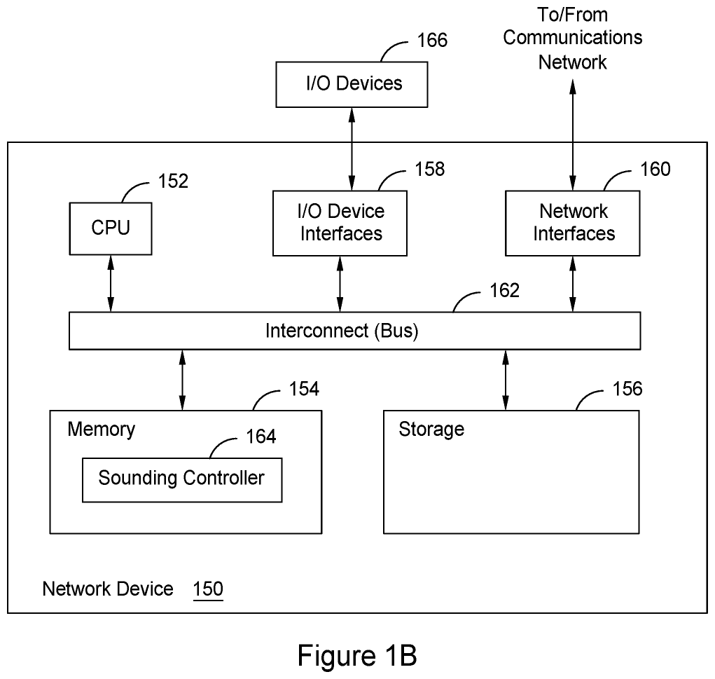

FIG. 1A depicts an AP operating to sound STAs. In the figure, an AP 102 with N antennas sends a data transmission to each station, STA 1-K 104, 106, in its basic service set (BSS). From the STAs 104, 106, it receives channel state information (CSI) feedback.

FIG. 1B depicts an example computing device configured to perform various aspects of the present disclosure, according to some embodiments of the present disclosure. In some embodiments, the network device 150 corresponds to an AP 102 and/or stations 104, 106 of FIG. 1. Although depicted as a physical device, in embodiments, the network device 150 may be implemented using virtual device(s) and/or across a number of devices (e.g., in a cloud environment).

As illustrated, the network device 150 includes a CPU 152, memory 154, storage 156, a network interface 160, and one or more I/O interfaces 158. In the illustrated embodiment, the CPU 152 retrieves and executes programming instructions stored in memory 154, as well as stores and retrieves application data residing in storage 156. The CPU 152 is generally representative of a single CPU and/or GPU, multiple CPUs and/or GPUs, a single CPU and/or GPU having multiple processing cores, and the like. Memory 154 is generally included to be representative of a random access memory. Storage 156 may be any combination of disk drives, flash-based storage devices, and the like, and may include fixed and/or removable storage devices, such as fixed disk drives, removable memory cards, caches, optical storage, network attached storage (NAS), or storage area networks (SAN).

In some embodiments, I/O devices 166 (such as keyboards, monitors, etc.) are connected via the I/O interface(s) 158. Further, via network interface 160, network device 150 can be communicatively coupled with one or more other devices and components (e.g., via a network, which may include the Internet, local network(s), wireless networks, and the like). As illustrated, the CPU 152, memory 154, storage 156, network interface(s) 160, and I/O interface(s) 158 are communicatively coupled by one or more buses 162.

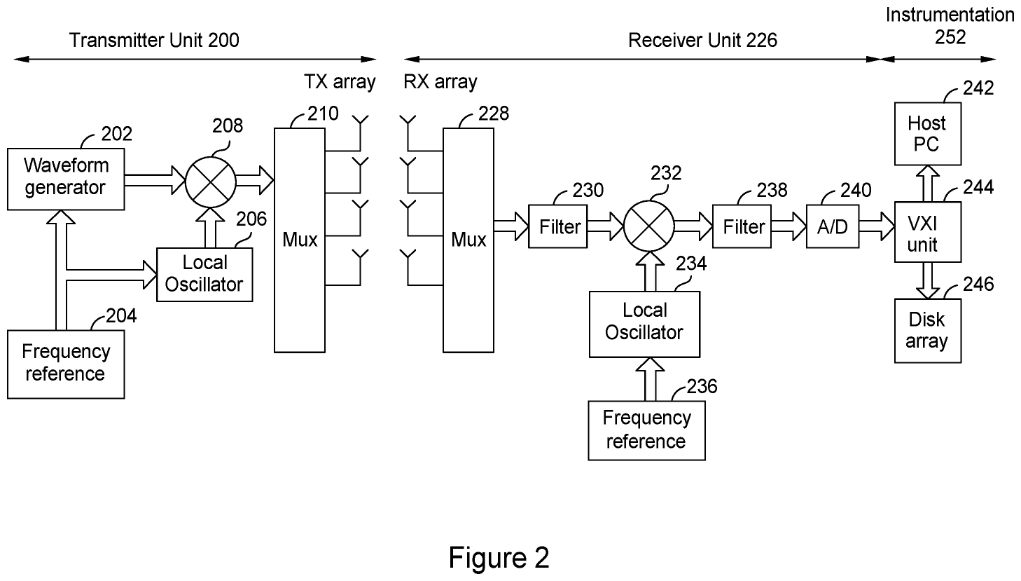

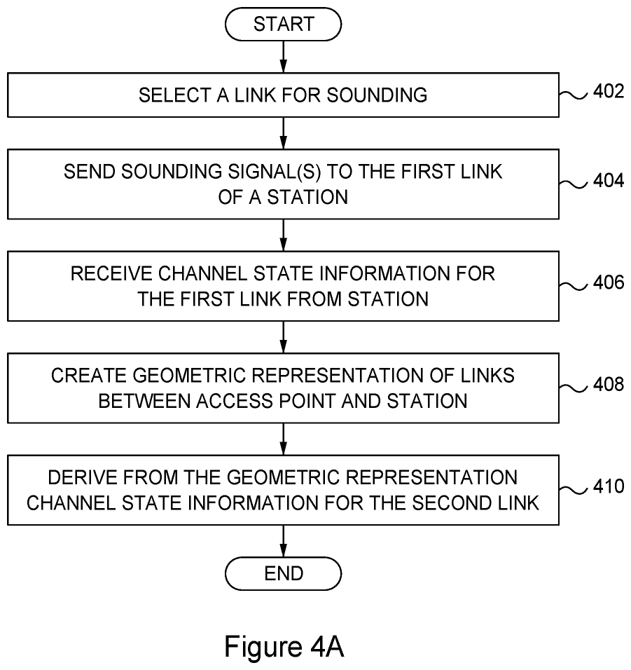

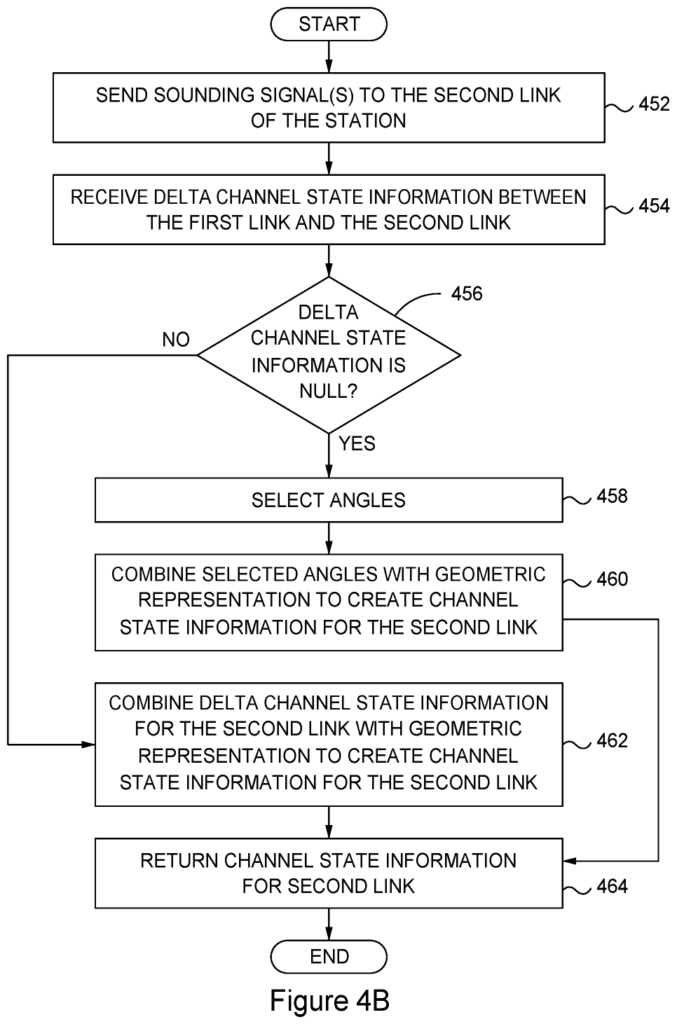

In the illustrated embodiment, memory 154 includes a sounding controller 164, which may perform one or more embodiments discussed above (e.g., blocks 402-410, 452-464 in the methods depicted in FIGS. 4A and 4B). The sounding controller 164 may generate sounding signals, according to FIG. 2. Although depicted as discrete components for conceptual clarity, in embodiments, the operations of the depicted components (and others not illustrated) may be combined or distributed across any number of components. Further, although depicted as software residing in memory 154, in embodiments, the operations of the depicted components (and others not illustrated) may be implemented using hardware, software, or a combination of hardware and software.

Wi-Fi7/8 devices support two or more Wi-Fi transceivers (in various degrees of simultaneity) to support multilink devices (MLDs). One purpose of sounding is to characterize the channel from a multipath (spatial) point of view.

FIG. 2 depicts a basic system for multi-tone sounding. In the figure, the transmitter unit 200 (e.g., the AP in FIG. 1) includes waveform generator 202, frequency reference 204, local oscillator 206, mixer 208, and multiplexer 210 for the transmitter array of antennas. The receiver unit 226 (e.g., an STA as shown in FIG. 1) includes a receiver array of antennas connected to multiplexer 228, a first filter 230, a mixer 232, a local oscillator 234, a frequency reference 236, a second filter 238, an A/D converter 240. An attached, optional instrumentation system 252 for collecting data includes a Versa Module Eurocard extension for instrumentation VXI bus unit 244, a disk array 246, and a host PC 242. The transmitter unit waveform generator 202 creates a set of simultaneous tones, and the mixer 208 up-converts them to a radio frequency. The tones are applied via the multiplexer 210 to the transmitter array. The receiver array receives the signals via multiplexer 228 and filters them in first filter 230. The mixer 232 down-converts the radio frequency signals to baseband signals, which are filtered by second filter 238 and converted to a digital signal for VXI instrument bus unit 244. The digital signal is provided to an array of disks 246 for storage and a host PC 242 for display.

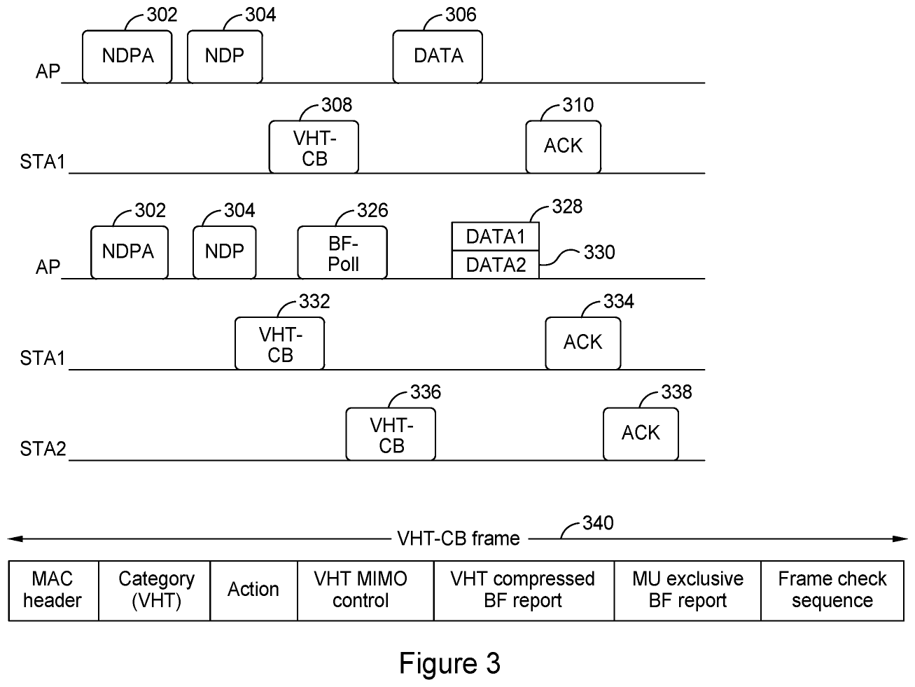

FIG. 3 depicts frames used in sounding and beam forming. In one embodiment, frames used in sounding are the null data packet announcement frame (NDPA) 302, the null data packet frame (NDP) 304, and an 802.11ac (or equivalent HE/EHT) frame called the very high throughput (VHT) (or equivalent HE/EHT) CB frame 308 containing a compressed beamforming report. The NDPA frame 302 announces the sending of the NDP frame 304. The NDP frame 304 is a pilot frame for the STAs to estimate the downlink RF channels. In one embodiment, the STAs receive the NDP frame 304, estimate the channel matrix, and apply a transform using a Givens rotation matrix G, a diagonal matrix D, and an Identity matrix to the channel matrix to create compressed channel information. This compressed channel information is fed back to the AP in the VHT-CB (or equivalent HE/EHT) frame 308. FIG. 3 also depicts the contents of the VHT-CB (or equivalent HE/EHT) frame 340. VHT-CB (or equivalent HE/EHT) frame 340 includes a MAC header, the frame category, the action, VHT-MIMO (or equivalent HE/EHT) control, the VHT (or equivalent HE/EHT) compressed beamforming (BF) report, the MU exclusive beam forming report, and a frame check sequence. The VHT-compressed (or equivalent HE/EHT) BF report field includes the sequence of angles in the Givens rotation matrix and average signal-to-noise information. The MU-exclusive BF report field contains the per-tone SNR deviations for a set of subcarriers. If beamforming is desired, the MLD AP transmits a beamformed data frame 306 using the reconstructed CSI from the compressed channel information. The non-AP MLD STA sends an acknowledgment 310 in response to beamformed data frame 306.

In the case of multi-user beamforming, the AP sends a beamforming poll frame 326 requesting that an STA transmit a VHT-CB (or equivalent HE/EHT) frame 332. After gathering all VHT-CB (or equivalent HE/EHT) frames 332, 336, the AP transmits beamformed data frames 328, 330 with multiple data streams to the associated STAs. If the STAs correctly decode the data, they send back an acknowledgment (ACK) frame 334, 338.

As mentioned, spatial-channel sounding (NDPA/NDP/VHT-CB or equivalent HE/EHT process) takes up a lot of airtime. It is currently handled by a dedicated NDPA frame+NDP+extended feedback (eFB such as the VHT-CB (or equivalent HE/EHT) frame and can take one or more milliseconds to execute, thus having a negative impact on MAC efficiency if sounding has to be performed regularly. Sounding delays get even worse with channel characterizations over even more combinations of AP/STA pairs in a multilink AP.

FIG. 4A depicts a flow of operations for sounding, in an embodiment. In block 402, the AP selects a first link for sounding. In one embodiment, the selection is based on the link in a band with the highest received signal strength information to signal-to-noise (RSSI/SNR) ratio (e.g., 2.4 GHz) as seen by the AP MLD or non-AP MLD STA. In another embodiment, the AP selects a link based on its power save (PS) state (i.e., avoid links of an MLD bundle that are out-of-service, etc.). In yet another embodiment, the AP selects two simultaneous links in the MLD (e.g., based on unique to MLD knowledge such as channel separation), better approximation/less translation error (e.g., a wider bandwidth such as is typically found at 6 GHz or 5 GHZ) or a smaller expected Delta CSI.

In block 404, the AP MLD sends a sounding signal to the selected first link of the non-AP MLD STA. The sounding signal or signals may be sent according to the frames described above.

In block 406, the AP receives CSI for the first link from the non-AP MLD STA. Sounding results in CSI, which is captured in a channel matrix H. The matrix describes the characteristics of the multiple paths between each transmitter and each receiver. For example, a system with two transmitters and two receivers has a channel matrix,

$$H = [ \begin{matrix}{h}_{00} & {h}_{01} \\ {h}_{10} & {h}_{11}\end{matrix} ] ,$$

where the entries are the complex transmission coefficients. With many transmitters and receivers, the amount of data in the channel matrix can be large. The data can be compressed by performing a right singular transformation of the channel matrix.

In addition, from the channel matrix H, a power-delay profile function can be derived.

$${P}_{h} ( τ ) = {lim}_{T \to ∞} ( \frac{1}{2 T} ) {\int }_{- T}^{T} {\vert h ( t , τ ) \vert}^{2} dt .$$

The power-delay profile function gives the intensity of a signal received through a multipath channel as a function of time delay. The time delay is the difference in travel time between multipath arrivals.

In block 408, the CSI is converted to a geometric representation of a channel. The geometric representation of a channel can take several forms. One form is a sparse power-delay profile plus phase information per peak (e.g., delay, magnitude, and phase per tap). Another form is a regularly-sampled power delay profile plus phase information per peak (e.g., magnitude and phase for each delay up to a maximum delay). Yet another form is similar to the two previous forms but uses I/Q (phasors) instead of magnitude and phase I/Q (phasor) in the frequency or time domain or even (with some manipulation) steering matrix (matrix V) representations. These geometric representations are independent of the band or link (2.4, 5, 6 GHZ). This independence allows the geometric representation of one band, say the 5 GHz band, to be transformed into a geometric representation of a different band, say the 6 GHz band, over the coherence time Tc of a channel.

In block 410, the AP MLD derives CSI for a second link.

FIG. 4B depicts a flow of operations for a function that derives CSI for the second link.

In block 452, the AP MLD sends a sounding signal or signals to a second link of the STA.

In block 454, the AP MLD receives delta CSI for the second link. The delta CSI is the difference between CSI for the first link and the second link. Such delta information is carried on the delta channel (as the extended feedback) or (e.g., if CSI is obtained from a broadcast NDPA+NDP) as extra fields in the extended feedback sent on the “fully sounded channel.” The delta CSI allows for the compression of the information, thereby significantly reducing the amount of information returned by the STA.

In block 456, the AP MLD determines whether the delta CSI is null.

If the delta CSI is not null, the AP MLD combines the delta CSI for the second link with the geometric representation to create CSI for the second link.

If the delta CSI is null, as determined in block 406, the more time-consuming sounding process (NDPA, NDP, eFB) is only performed on one link of a non-APMLD STA, realizing an overhead savings of up to 67%.

In block 458, phase angles reported in the eFB are selected. The phase angles in the eFB are carefully chosen so as to realize band independence. In particular, the number of bits used to represent the phase angle may be optimized with more bits than for a single-link AP but fewer than for a multilink AP.

The phase info associated with each tap of the “delta channel” is determined from a) the phase info associated with each tap of the “fully sounded channel,” b) the power-delay profile delays, and c) knowledge of the difference in wavelengths for a channel of the second link and the first link.

In addition, the relationship between the power-delay profile magnitude, delay and phase info, and matrix V permits the beamforming matrix derived by the STA for the first link to be used when beamforming to the same STA for the second link, with augmentation from the delta CSI if present or no augmentation if the delta CSI was not present or was reported as insignificantly different (i.e., roughly the same thus a null delta).

In block 460, the selected phase angles are combined with the geometric representation generated at block 408 of FIG. 4A based on sounding the first link to create the CSI for the second link. In block 462, the function returns the CSI for the second link. In block 464, the CSI for the second link is returned.

In one embodiment, a non-AP STA can indicate via capabilities whether it can support extended feedback reporting.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of steps in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two steps shown in succession may, in fact, be executed substantially concurrently, or the steps may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method for characterizing propagation paths of a plurality of radio frequency (RF) links including a first RF link and a second RF link, the method comprising:
sounding the first RF link with a sounding signal;
obtaining first channel state information for the first RF link from a station having a receiver receiving the sounding signal, the first channel state information characterizing propagation over the first RF link to the receiver;
converting the first channel state information into a geometric representation that applies to the plurality of RF links; and
obtaining second channel state information for the second RF link based on the geometric representation.

2. The method of claim 1, wherein the first channel state information is in a compressed form by applying a transform to the first channel state information.

3. The method of claim 1, wherein obtaining second channel state information for the second RF link includes:
sounding the second RF link;
in response to sounding the second RF link, receiving, from the station, delta channel state information, the delta channel state information being a difference between the first channel state information and the second channel state information at the station; and
combining the delta channel state information and the geometric representation to obtain the second channel state information.

4. The method of claim 3, wherein the delta channel state information is in a compressed form by applying a transform to the delta channel state information.

5. The method of claim 1, wherein the sounding signal is a multi-tone signal.

6. The method of claim 5, wherein sounding the first RF link includes sending a null packet data announcement frame (NDPA), a null data packet frame (NDP) to the station, and receiving a beamforming report from the station.

7. The method of claim 1, wherein the first RF link has a wider bandwidth than the second RF link.

8. A system for characterizing wireless propagation paths of a plurality of radio frequency (RF) links, the system comprising:
an access point having multiple transmitters and receivers;
wherein the plurality of RF links, including a first RF link and a second RF link, is available between the access point and a station having multiple transmitters and multiple receivers;
wherein the access point is configured to:
sound the first RF link with a sounding signal;
obtain first channel state information for the first RF link from the station, the first channel state information characterizing propagation over the first RF link to one receiver of the multiple receivers of the station;
convert the first channel state information into a geometric representation that applies to the plurality of RF links; and
obtain second channel state information for the second RF link based on the geometric representation.

9. The system of claim 8, wherein the first channel state information is in a compressed form.

10. The system of claim 8, wherein the access point being configured to obtain the second channel state information for the second RF link includes being configured to:
sound the second RF link;
in response to sounding the second RF link, receive from the station delta channel state information, the delta channel state information being a difference between the first channel state information and the second channel state information at the station; and
combine the delta channel state information and the geometric representation to obtain the second channel state information.

11. The system of claim 10, wherein the delta channel state information is in a compressed form.

12. The system of claim 8, wherein the sounding signal is a multi-tone signal.

13. The system of claim 12, wherein the access point being configured to sound the first RF link includes the access point being configured to send a null packet data announcement frame (NDPA), a null data packet frame (NDP) to the station, and receive a beamforming report from the station.

14. The system of claim 8, wherein the first RF link has a wider bandwidth than the second RF link.

15. A non-transitory computer-readable medium encoding instructions, which, when executed by a processor of an access point coupled to a wireless medium, cause the access point to characterize wireless propagation paths of a plurality of radio frequency channels including a first RF link and a second RF link by:
sounding the first RF link with a sounding signal;
obtaining first channel state information for the first RF link from a station having a receiver receiving the sounding signal, the first channel state information characterizing propagation over the first RF link to the receiver;
converting the first channel state information into a geometric representation that applies to the plurality of RF links; and
obtaining second channel state information for the second RF link based on the geometric representation.

16. The non-transitory computer-readable medium of claim 15, wherein the first channel state information is in a compressed form by applying a transform to the first channel state information.

17. The non-transitory computer-readable medium of claim 15, wherein the instructions further cause:
sounding the second RF link;
in response to sounding the second RF link, receiving from the station delta channel state information, the delta channel state information being a difference between the first channel state information and the second channel state information at the station; and
combining the delta channel state information and the geometric representation to obtain the second channel state information.

18. The non-transitory computer-readable medium of claim 17, wherein the delta channel state information is in a compressed form by applying a transform to the delta channel state information.

19. The non-transitory computer-readable medium of claim 15, wherein the sounding signal is a multi-tone signal.

20. The non-transitory computer-readable medium of claim 19, herein sounding the first RF link includes sending a null packet data announcement frame (NDPA), a null data packet frame (NDP) to the station, and receiving a beamforming report from the station.
